(19) United States
(12) Patent Application Publication
(10) Pub. No.: US 2022/0292336 A1
(43) Pub. Date: Sep. 15, 2022

(54) Optical Information Processing Device

(71) Applicant: Nippon Telegraph and Telephone Corporation, Tokyo (JP)

(72) Inventors: Hirotaka Ono, Musashino-shi, Tokyo (JP); Mitsumasa Nakajima, Musashino-shi, Tokyo (JP); Shiori Konisho, Musashino-shi, Tokyo (JP); Kenji Tanaka, Musashino-shi, Tokyo (JP); Toshikazu Hashimoto, Musashino-shi, Tokyo (JP)

(21) Appl. No.: 17/636,277

(22) PCT Filed: Aug. 20, 2019
(86) PCT No.: PCT/JP2019/032511

§ 371 Date: Feb. 17, 2022

(51) Int. Cl. G06N 3/067; H04J 14/04

(52) U.S. Cl. CPC G06N 3/067; H04J 14/04

(57) ABSTRACT

An optical information processing device is a device that realizes reservoir computing using light. In the optical information processing device, a portion including a light source, an optical modulator, and an optical splitter is an input layer, a portion including optical couplers, a mode multiplexer, a mode demultiplexer, a multi-mode fiber, and an amplification and attenuator is a reservoir layer, a portion including an optical detector, a multiplier, and a summer is an output layer. The reservoir computing with light includes the input layer, the reservoir layer, and the output layer, and further includes a calculation circuit.

### TECHNICAL FIELD

The present disclosure relates to an information processing device that performs data estimation through machine learning using light.

### BACKGROUND ART

Various intellectual businesses have been created by autonomously executing, on machines, data processing and analysis that has been performed manually so far using information processing by artificial intelligence or machine learning. One of the technologies that support this trend is machine learning using an artificial neural network. In machine learning, reservoir computing (RC) that is one of recurrent neural networks with self-feedback, is attracting attention. Since RC is composed of an input layer, a reservoir layer, and an output layer, and an inter-neuron connection that requires learning is an only lead-out that connects the reservoir layer and the output layer. Thus, learning-based network optimization is not required, and learning can be simplified and speeded up. Further, because RC has a good affinity with optical circuits, research on optical mounting using high-speed modulated light and optical circuits is underway. In this, reservoir computing of 50 to 200 neurons has been realized by a configuration using a single delay line loop (NPLs 1 and 2).

### CITATION LIST

### Non Patent Literature

NPL 1: F. Duport et al., “All-optical reservoir computing,” Optics Express, 2012, vol. 20, no. 20, pp. 22783-22795.
NPL 2: M. Nakajima et al., “Coherently driven ultrafast complex-valued photonic reservoir computing,” Proceedings of CLEO2018, paper SM1C.4.

### SUMMARY OF THE INVENTION

Since, for example, tens of thousands of nodes are required for machine learning, even for handwritten character recognition, which is an elementary problem, even in an optical information processing device that performs information processing through reservoir computing, the number of nodes required is on a scale of around 10,000 units. However, due to the complexity of optical mounting, the number of nodes currently realized is about several tens to several hundred, and a range in which optical circuits are applicable is currently limited.

The present disclosure has been made in view of such circumstances, and an object of the present disclosure is to provide an optical information processing device capable of realizing tens of thousands of nodes.

An optical information processing device according to the present disclosure includes: a unit configured to generate and modulate light; a plurality of first optical couplers configured to receive a part of an optical electric field of light waves modulated by the modulation unit and split; a mode multiplexer configured to convert M light waves (M is an integer equal to or greater than 2) from the plurality of first optical couplers into M modes and multiplex the light waves; a multi-mode fiber configured to receive the multiplexed light wave from the mode multiplexer; a mode demultiplexer configured to receive the light wave through the multi-mode fiber, demultiplex the light wave into single-mode fibers different from mode to mode, and split a part of a light amplitude of each mode; a plurality of second couplers configured to split a part of the optical electric field of the light waves received from the mode demultiplexer; optical fibers, each of which is formed between the first optical coupler and the second optical coupler and configured to feed a part of an output of the mode demultiplexer back to an input of the mode multiplexer; and an optical detection unit configured to square an optical electric field of a remaining part of the output of the mode demultiplexer to detect a split output of the second optical coupler.

Further, an optical information processing device according to the present disclosure includes a light source configured to generate continuous light; an optical modulator configured to modulate the continuous light; a plurality of first optical couplers configured to receive a part of an optical electric field of light waves modulated by the optical modulator and split; a mode multiplexer configured to convert M light waves (M is an integer equal to or greater than 2) from the plurality of first optical couplers into M modes and multiplex the light waves; a multi-mode fiber configured to receive the multiplexed light waves from the mode multiplexer; a mode demultiplexer configured to receive the light waves through the multi-mode fiber, demultiplex the light waves into single-mode fibers different from mode to mode, and split a part of a light amplitude of each mode; a plurality of second optical couplers configured to split a part of the optical electric field of light waves received from the mode demultiplexer; optical fibers, each of which is formed between the first optical coupler and the second optical coupler and configured to feed a part of an output of the mode demultiplexer back to an input of the mode multiplexer; and an optical detector configured to square an optical electric field of a remaining part of the output of the mode demultiplexer to detect a split output of the second optical coupler.

The optical information processing device according to the present disclosure has an advantage of achieving the number of nodes of tens of thousands as in the related art and having advanced learning functions such as handwritten character recognition.

### BRIEF DESCRIPTION OF DRAWINGS

FIG. 1 is a block diagram illustrating an optical information processing device according to an embodiment of the present disclosure.

FIG. 2 is a diagram illustrating Santa-Fe contest data from start to 3000 points.

FIG. 3 is a block diagram illustrating an output layer of the optical information processing device in learning and predicting MNIST data.

FIG. 4 is diagrams illustrating examples of a prediction result of the MNIST data.

### DESCRIPTION OF EMBODIMENT

Hereinafter, an embodiment of the present invention will be described with reference to the drawings.

### Embodiment

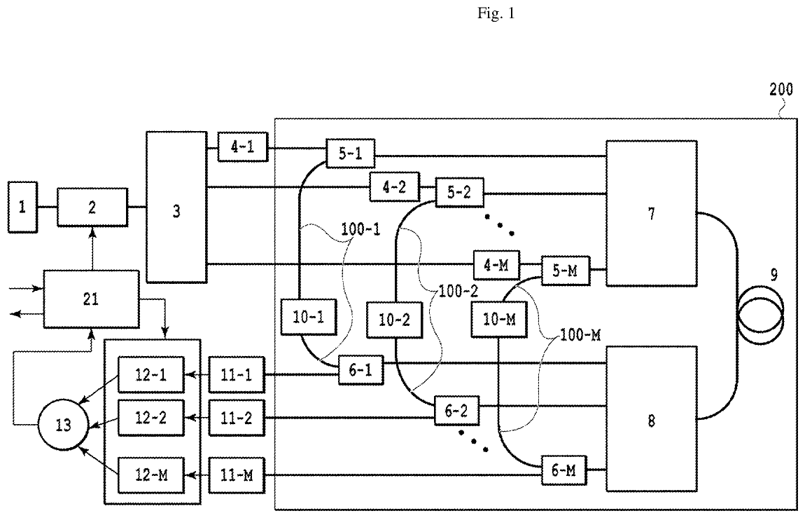

FIG. 1 is a block diagram illustrating an optical information processing device according to the present embodiment. The optical information processing device according to the present embodiment includes a light source 1 that generates continuous light, an optical modulator 2 that modulates the continuous light with a signal from a calculation circuit 21 to be described below, first optical couplers 5-1 to 5-M that receive a part of an optical electric field of light waves intensity-modulated by the optical modulator 2 and split by an optical splitter 3 to be described below, a mode multiplexer 7 that converts M light waves (M is an integer equal to or greater than 2) from the first optical couplers 5-1 to 5-M into M modes and multiplexes the light waves, a multi-mode fiber (M-mode fiber) 9 that receives the multiplexed light wave from the mode multiplexer 7, a mode demultiplexer 8 that receives light waves through the multi-mode fiber 9, demultiplexes the light waves into single-mode fibers different from mode to mode, and splits a part of a light amplitude of each mode, second optical couplers 6-1 to 6-M that split a part of an optical electric field of light waves received from the mode demultiplexer 8, optical fibers 100-1 to 100-M formed between the first optical couplers 5-1 to 5-M and the second optical couplers 6-1 to 6-M and feeding a part of an output of the mode demultiplexer 8 back to inputs of the mode multiplexer 7, and optical detectors 11-1 to 11-M that detect optical electric fields of a remaining part of the outputs of the mode demultiplexer 8 by squaring. The calculation circuit 21 inputs and outputs signals and also stores data.

Further, the optical information processing device includes an optical splitter 3 that splits the light waves modulated by the optical modulator 2 into M waves (M is an integer equal to or greater than 2), variable light attenuators 4-1 to 4-M that amplify or attenuate the light waves output from the optical splitter 3, amplification attenuators 10-1 to 10-M that attenuate an optical electric field of the light waves output from the second optical couplers 6-1 to 6-M and output the light waves to the first optical couplers 5-1 to 5-M, optical detectors 11-1 to 11-M that detect the light waves from the second optical couplers 6-1 to 6-M by squaring and convert the light waves into voltage signals, multipliers 12-1 to 12-M that add a weight of a virtual node state from the calculation circuit 21 for each mode to the received voltage signals, a summer 13 that outputs a linear sum of the voltage signals to which the weight has been added, and the calculation circuit 21 that performs input and output of data, temporarily stores the voltage signal input from the summer 13 in a storage unit at a learning timing, performs a recursive calculation using a correct signal, and sets an obtained value as a coefficient of the multipliers 12-1 to 12-M.

A method of operating the optical information processing device will be described below. The light source 1 generates continuous light. The optical modulator 2 intensity-modulates the continuous light emitted from the light source 1. An example of a unit for generating and modulating light includes a light source (for example, an LN modulator) and an optical modulator (for example, an LN modulator). The optical splitter 3 splits the intensity-modulated light into M waves. The variable optical attenuators 4-1 to 4-M (M is an integer equal to or greater than 2) attenuate the optical electric field of the optical waves split into the M waves. The twelve optical couplers (first optical couplers) 5-1 to 5-M merge a part of the optical electric field. The twelve optical couplers (second optical couplers) 6-1 to 6-M split a part of the optical electric field. An example of a unit for splitting or merging a part of the optical electric field includes an optical coupler. The mode multiplexer 7 including a single-mode fiber on a multi-port side and a multi-mode fiber on a single-port side converts M different inputs into different modes and couples the modes to a multi-mode fiber (fiber which is the same as or similar to the multi-mode fiber 9 described below). The mode demultiplexer 8 is the same as the mode multiplexer 7, and is used in a state where input and output directions are reversed. There are the multi-mode fiber 9 that allows propagating M modes, the amplification attenuators 10-1 to 10-M that amplify or attenuate the light waves, the optical detectors 11-1 to 11-M that detect the light waves and convert the light waves into voltage signals, the multipliers 12-1 to 12-M that multiply a received voltage signal by a predetermined coefficient, the summer 13, and the calculation circuit 21.

The optical information processing device according to the present embodiment is a device that realizes reservoir computing with light. A portion including the light source 1, the optical modulator 2, and the optical splitter 3 is an input layer. A portion including the first optical couplers 5-1 to 5-M, the second optical couplers 6-1 to 6-M, the mode multiplexer 7, the mode demultiplexer 8, the multi-mode fiber 9, and the amplification attenuators 10-1 to 10-M is a reservoir layer. A portion including the optical detectors 11-1 to 11-M, the multipliers 12-1 to 12-M, and the summer 13 is an output layer. Reservoir computing with light includes the input layer, the reservoir layer, and the output layer. Further, the optical information processing device according to the present embodiment is formed by including the calculation circuit 21.

The input layer, the reservoir layer, and the output layer operate as follows.

The input layer operates as follows. The input layer performs mask processing for amplitude-modulating, using the optical modulator 2, the continuous light generated by the light source 1 with desired data (data input from the calculation circuit 21) in which the length of one data value is τ, and dividing a time τ into θ time, and multiplying by a random value. In this case, N is a positive number, and τ=Nθ. That is, the continuous light is modulated with mⱼu(t) in the optical modulator 2, when a data signal is denoted by u(t) and a mask is denoted by mᵢ (i=1, 2, . . . , N). N is the number of virtual nodes in the reservoir layer. An optical electric field of the light waves modulated by the optical modulator 2 is split into M waves by the optical splitter 3, and M randomly assigned attenuation amounts aⱼ (j=1, 2, . . . , M) are given to the M waves in the variable optical attenuators 4-1 to 4-M.

Although the light source and the optical modulator are different components in the present embodiment, the light source and the optical modulator may be integrated by using direct modulation of a semiconductor laser.

The reservoir layer operates as follows. The mode multiplexer 7 converts the M light waves prepared in the input layer into light waves of M modes, multiplexes the converted light waves, and input to the multi-mode fiber 9. An optical circuit unit 200 is formed, and in the optical circuit unit 200, an output of the multi-mode fiber 9 is demultiplexed into single-mode fibers different from mode to mode using the mode demultiplexer 8 and a part of a light amplitude of each mode is split into the second optical couplers 6-1 to 6-M, then a desired gain or loss Gⱼ is added using the amplification attenuators 10-1 to 10-M, the part of the mode light amplitude is input to the first optical couplers 5-1 to 5-M, and a part of the optical electric field is fed back to each mode light input. The optical circuit unit 200 refers to a portion having a function of feeding a part of an optical electric field back to each mode light input. The optical circuit unit 200 includes a first optical coupler, a second optical coupler, a mode multiplexer, a mode demultiplexer, a multi-mode fiber, an amplification attenuator, and a portion formed between the first optical coupler and the second optical coupler and feeding a part of the output of the mode demultiplexer back to an input of the mode multiplexer, and the optical circuit unit 200 is formed of, for example, optical fibers 100-1 to 100-M. The optical circuit unit 200 does not include a variable optical attenuator.

Here, a delay time of the optical circuit unit 200 is set such that a delay time T of a basic mode is T=(N+1)θ, and an inter-mode group delay difference Dⱼ₋₍ⱼ₊₁₎ between a j-th mode and a (j+1)-th mode is

Dⱼ₋₍ⱼ₊₁₎≈θ. Math. 1

In this case, a delay time Tⱼ of the j-th mode is

T≈(N+j)θ. Math. 2

In order to realize such a setting, the modes having very close propagation constants among the propagation allowing modes of the multi-mode fiber are treated as the same mode group. For example, in a 10-mode fiber, each of modes LP₀₁, LP₁₁ₒ, LP₁₁ₑ, LP₂₁ₒ, LP₂₁ₑ, LP₀₂, LP₃₁ₒ, LP₃₁ₑ, LP₁₂ₒ, and LP₁₂ₑ can be propagated, but because the two modes LP₁₁ₒ and LP₁₁ₑ, the three modes LP₂₁ₒ, LP₂₁ₑ, and LP₀₂, and the four modes LP₃₁ₒ, LP₃₁ₑ, LP₁₂ₒ, and LP₁₂ₑ consists of the same mode group in which propagation constants are very close, and delay times are substantially the same. Thus, the 10-mode fiber is treated as a 4-mode fiber in the present embodiment. An output electric field xᵢⱼ corresponding to a mode j of the mode demultiplexer 8 is

$${x}_{ij} = {\sum }_{i}^{N} {G}_{j} {x}_{ij} ( t - τ ) + {a}_{j} {m}_{i} u ( t ) . \qquad Math . 3$$

Further, the number of modes of the fiber used in the optical information processing device in which M modes are used is not limited to M, and M or more multiple modes are used in a situation in which an optical loss of the entire device is small, and unused optical electric fields due to unnecessary mode conversion is allowed.

The output layer operates as follows. Among M light waves demultiplexed by the mode demultiplexer 8, the optical detectors 11-1 to 11-M detect each of the light waves not split by the second optical coupler 6. The optical detectors 11-1 to 11-M are composed of a photodiode and a transimpedance amplifier, convert received light waves into currents by square detection, and then convert the currents into voltages. Examples of a photodetection unit that detects an optical electric field include an optical detector. The multipliers 12-1 to 12-M add a weight in a virtual node state for respective modes to the outputs of the optical detectors 11-1 to 11-M, and the summer 13 outputs a linear sum to the calculation circuit 21 as:

$$y ( t ) = {\sum }_{j}^{M} {\sum }_{i}^{N} {W}_{ij} {x}_{ij}^{2} ( t ) \qquad Math . 4$$

The calculation circuit 21 includes an external input and output for receiving data necessary for learning and input data necessary for prediction, and the like, or outputting, for example, data predicted by the optical information processing device. Further, an output voltage of the summer 13 is input to the calculation circuit 21. At the learning timing, a voltage signal input from the summer 13 is temporarily stored in a storage unit, recursive calculation is performed using a correct signal, and obtained values are used as coefficients of the multipliers 12-1, 12-2, . . . , and 12-M.

As the optical information processing device according to the present embodiment, as a multiple fiber:

θ≈Dⱼ₋₍ⱼ₊₁₎=1±0.05 Math. 5

an optical information processing device is produced in which a 100-mode fiber that is ns is used, and the number of virtual nodes in the reservoir layer is 200. That is, this optical information processing device is substantially equivalent to reservoir computing in which the number of nodes is 20,000. Using this optical information processing device, the performance of the optical information processing device according to the present embodiment was evaluated using two pieces of test data including Santa-Fe contest data that is a time-series prediction problem, and MNIST data that is handwritten number image recognition.

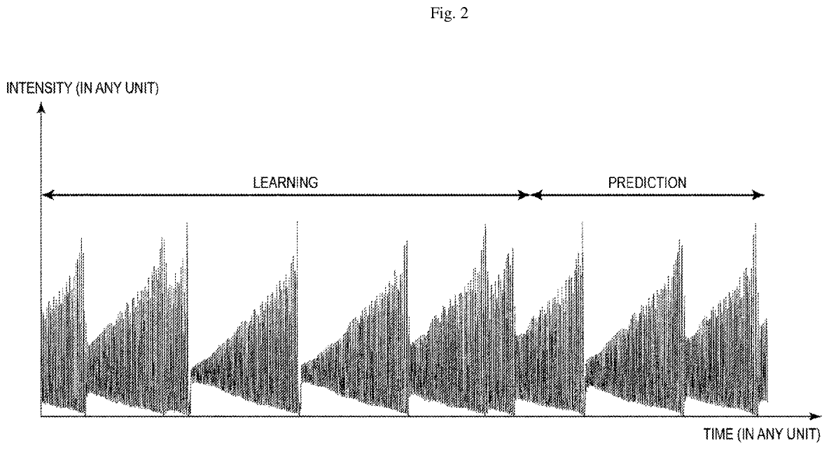

FIG. 2 illustrates the Santa-Fe contest data from the start to 3000 points, and data at the 3000 points was used for performance evaluation. For learning, 2000 points from the start were used, and the following 1000 data points were used for prediction data. The optical information processing device according to the present embodiment was operated as a one-step ahead prediction, and the accuracy of predicted values of 1000 points was evaluated using a normalized mean square error (NMSE). As the result, it was confirmed that prediction could be made with a very small error of MNSE=1.5×10⁻⁶.

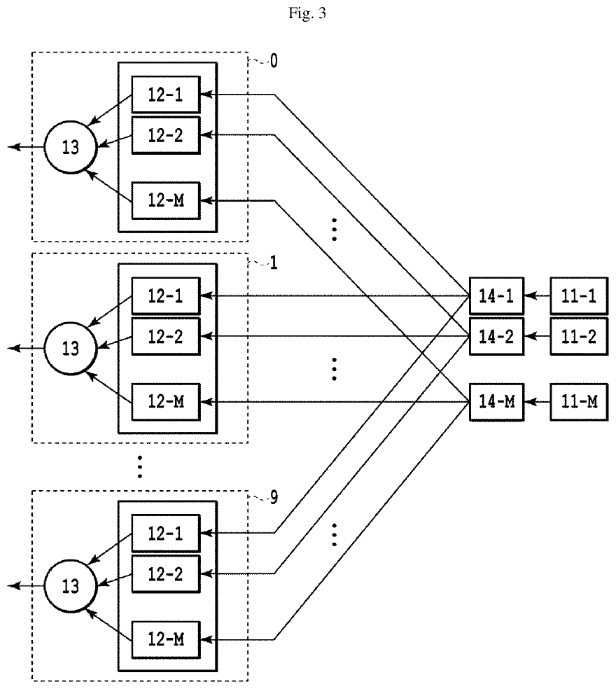

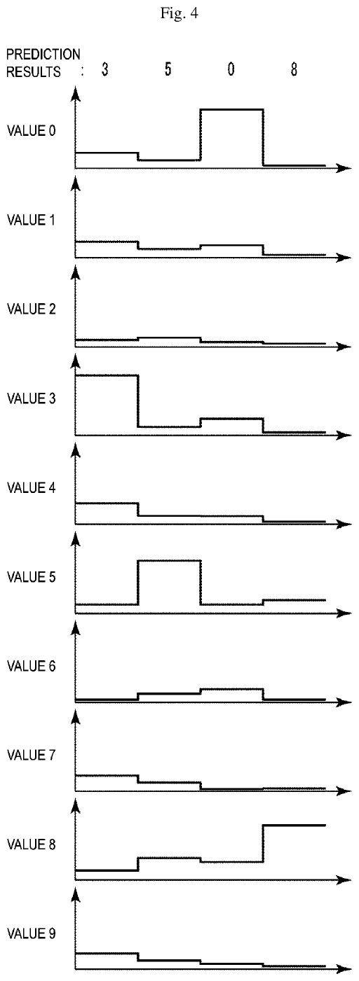

In learning and prediction of Mixed National Institute of Standards and Technology (MNIST) data, the output layer of the optical information processing device is changed to a form illustrated in FIG. 3. That is, a voltage signal from the optical detector 11-M is split into 10 by a splitter 14-M, and input to L (for example, 10) sets of multiplier and adder surrounded by dotted lines corresponding to numbers 0 to 9 in FIG. 3. L may be an integer equal to or greater than 2. Here, an output voltage corresponding to a value of prediction results becomes a predetermined value or more, and output voltages corresponding to other values become less than the predetermined value. FIG. 4 illustrates an example of the output voltage when L is 10. When the prediction results are 3, 5, 0, and 8, output voltages of the adders corresponding to the values 3, 5, 0, and 8 have a large value, whereas output voltages of the other adders have a small value. Thus, the calculation circuit 21 determines a prediction result. As a result of performing learning with 1000 pieces of data among the MNIST data and performing performance evaluation with 500 pieces of data, excellent performance with a correct answer rate of 99.4% was obtained.

### INDUSTRIAL APPLICABILITY

The present disclosure can be applied to an information processing device that performs data estimation through machine learning using light.

1. An optical information processing device, comprising:
a unit configured to generate and modulate light;
a plurality of first optical couplers configured to receive a part of an optical electric field of light waves modulated by the modulation unit and split;
a mode multiplexer configured to convert M light waves (M is an integer equal to or greater than 2) from the plurality of first optical couplers into M modes and multiplex the light waves;
a multi-mode fiber configured to receive the multiplexed light wave from the mode multiplexer;
a mode demultiplexer configured to receive the light wave through the multi-mode fiber, demultiplex the light wave into a plurality of single-mode fibers different from mode to mode, and split a part of a light amplitude of each mode;
a plurality of second couplers configured to split a part of the optical electric field of light waves received from the mode demultiplexer;
a plurality of optical fibers, each of which is formed between the first optical coupler and the second optical coupler and configured to feed a part of an output of the mode demultiplexer back to an input of the mode multiplexer; and
a plurality of optical detection units configured to square an optical electric field of a remaining part of the output of the mode demultiplexer to detect a split output of the second optical coupler.

2. An optical information processing device, comprising:
a light source configured to generate continuous light;
an optical modulator configured to modulate the continuous light;
a plurality of first optical couplers configured to receive an optical electric field of light waves modulated by the optical modulator and split;
a mode multiplexer configured to convert M light waves (M is an integer equal to or greater than 2) from the plurality of first optical couplers into M modes and multiplex the light waves;
a multi-mode fiber configured to receive the multiplexed light wave from the mode multiplexer;
a mode demultiplexer configured to receive the light wave through the multi-mode fiber, demultiplex the light wave into a plurality of single-mode fibers different from mode to mode, and split a part of a light amplitude of each mode;
a plurality of second optical couplers configured to split a part of an optical electric field received from the mode demultiplexer;
a plurality of optical fibers, each of which is formed between the first optical coupler and the second optical coupler and configured to feed a part of an output of the mode demultiplexer back to an input of the mode multiplexer; and
a plurality of optical detectors configured to square an optical electric field of a remaining part of the output of the mode demultiplexer to detect a split output of the second optical coupler.

3. The optical information processing device according to claim 1, comprising:
an optical splitter configured to split light waves modulated by the modulation unit or the optical modulator into M waves (M is an integer equal to or greater than 2);
a plurality of variable light attenuators configured to amplify or attenuate the light waves output from the optical splitter;
a plurality of amplification attenuators configured to attenuate an optical electric field of light waves output from the plurality of second optical couplers and output the light waves to the plurality of first optical couplers;
a plurality of multipliers configured to add a weight of a virtual node state for respective modes to voltage signals received from the plurality of optical detectors configured to detect light waves from the plurality of second optical couplers and convert the light waves into voltage signals;
a summer in which the weight is added from the plurality of multipliers, the summer being configured to output a linear sum; and
a calculation circuit configured to input and output data, temporarily store a voltage signal input from the summer in a storage unit at a learning timing, perform a recursive calculation using a correct signal, and set an obtained value as a coefficient of the plurality of multipliers.

4. The optical information processing device according to claim 3,
wherein a voltage signal from the optical detector is split into L signals by the splitter, and
L sets of the plurality of multipliers and the summers receive the split signal voltages.

5. The optical information processing device according to claim 4, wherein the L is 10.

6. The optical information processing device according to claim 3,
wherein, mask processing includes:
amplitude-modulating continuous light generated by the unit configured to generate and modulate light or the light source, using the unit configured to generate and modulate the light or the optical modulator, with data input from the calculation circuit, the data having a length of one data value being τ,
dividing a time τ into θ time, and
multiplying θ time by a random value, and
when the mask processing is performed, τ=Nθ with N (N is a positive number) being a positive number is satisfied, and
an optical circuit unit including the optical coupler, the mode multiplexer, the mode demultiplexer, the multi-mode fiber, the amplification attenuator, and the optical fiber satisfies that a delay time of a basic mode is T=(N+1)θ, and an inter-mode group delay difference between a j-th mode and a (j+1) th mode is
Dⱼ₋₍ⱼ₊₁₎≈θ. Math. 1

7. The optical information processing device according to claim 2, comprising:
an optical splitter configured to split light waves modulated by the modulation unit or the optical modulator into M waves (M is an integer equal to or greater than 2);
a plurality of variable light attenuators configured to amplify or attenuate the light waves output from the optical splitter;
a plurality of amplification attenuators configured to attenuate an optical electric field of light waves output from the plurality of second optical couplers and output the light waves to the plurality of first optical couplers;
a plurality of multipliers configured to add a weight of a virtual node state for respective modes to voltage signals received from the plurality of optical detectors configured to detect light waves from the plurality of second optical couplers and convert the light waves into voltage signals;
a summer in which the weight is added from the plurality of multipliers, the summer being configured to output a linear sum; and
a calculation circuit configured to input and output data, temporarily store a voltage signal input from the summer in a storage unit at a learning timing, perform a recursive calculation using a correct signal, and set an obtained value as a coefficient of the plurality of multipliers.

8. The optical information processing device according to claim 4,
wherein, mask processing includes:
amplitude-modulating continuous light generated by the unit configured to generate and modulate light or the light source, using the unit configured to generate and modulate the light or the optical modulator, with data input from the calculation circuit, the data having a length of one data value being τ,
dividing a time τ into θ time, and
multiplying θ time by a random value, and
when the mask processing is performed, τ=Nθ with N (N is a positive number) being a positive number is satisfied, and
an optical circuit unit including the optical coupler, the mode multiplexer, the mode demultiplexer, the multi-mode fiber, the amplification attenuator, and the optical fiber satisfies that a delay time of a basic mode is T=(N+1)θ, and an inter-mode group delay difference between a j-th mode and a (j+1) th mode is
Dⱼ₋₍ⱼ₊₁₎≈θ. Math. 1

9. The optical information processing device according to claim 5,
wherein, mask processing includes:
amplitude-modulating continuous light generated by the unit configured to generate and modulate light or the light source, using the unit configured to generate and modulate the light or the optical modulator, with data input from the calculation circuit, the data having a length of one data value being τ,
dividing a time τ into θ time, and
multiplying θ time by a random value, and
when the mask processing is performed, τ=Nθ with N (N is a positive number) being a positive number is satisfied, and
an optical circuit unit including the optical coupler, the mode multiplexer, the mode demultiplexer, the multi-mode fiber, the amplification attenuator, and the optical fiber satisfies that a delay time of a basic mode is T=(N+1)θ, and an inter-mode group delay difference between a j-th mode and a (j+1) th mode is
Dⱼ₋₍ⱼ₊₁₎≈θ. Math. 1
